(19) United States
(12) Patent Application Publication
(10) Pub. No.: US 2010/0054934 A1
(43) Pub. Date: Mar. 4, 2010

(54) EXHAUST GAS TURBOCHARGER

(75) Inventors: Ralf Böning, Reiffelbach (DE); Claus Hartmut, Grünstadt (DE); Dirk Frankenstein, Worms (DE); Holger Fäth, Fussgönheim (DE); Jochen Held, Bolanden-Weierhof (DE); Stefan Krauss, Frankenthal (DE); Stefan Nowack, Kirchheimbolanden (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/595,282

(22) PCT Filed: Feb. 27, 2008
(86) PCT No.: PCT/EP08/52356

§ 371 Date: Oct. 9, 2009

(30) Foreign Application Priority Data
Apr. 16, 2007 (DE) 10 2007 017 824.9

(51) Int. Cl. F01D 25/24; B23P 11/00; F02B 33/34

(52) U.S. Cl. 415/214.1; 29/889.22; 60/605.1

(57) ABSTRACT

A turbocharger for a motor vehicle has a compressor housing, a turbine housing, a bearing housing, and at least one flange on the compressor side. The turbine housing is force-locked with the bearing housing by way of a fastening element that is arranged on the flange on the compressor side, thereby allowing the complete automatic assembly of the turbocharger.

The invention relates to an exhaust gas turbocharger.

When air is aspirated in conventional, non-supercharged internal combustion engines, a vacuum is created in the induction tract which increases as the rotational speed of the engine increases and limits the theoretically attainable performance of the engine. One possibility of counteracting this and thereby achieving a boost in performance is to use an exhaust gas turbocharger (EGT). An exhaust gas turbocharger, or turbocharger for short, is a supercharging system for an internal combustion engine by means of which the cylinders of the internal combustion engine are exposed to an increased supercharging pressure.

Their detailed structure and mode of operation is generally known and described for example in the publication: “Aufladung von PKW DI Ottomotoren mit Abgasturboladern mit variabler Turbinengeometrie” (“Supercharging automobile direct-injection spark-ignition engines with exhaust gas turbochargers with variable turbine geometry”), September 2006, Hans-Peter Schmalzl, and is therefore explained only briefly below. A turbocharger consists of an exhaust gas turbine in the exhaust gas stream (downstream path) which is connected via a common shaft to a compressor in the induction tract (upstream path). The turbine is set into rotation by the exhaust gas stream from the engine and thereby drives the compressor. The compressor increases the pressure in the induction tract of the engine such that as a result of said compression a greater volume of air is drawn into the cylinders of the internal combustion engine during the induction stroke than in the case of a conventional naturally-aspirated engine. More oxygen is available for combustion as a result. The torque and the power delivery are increased appreciably due to the increasing mean effective pressure of the engine. Supplying a greater volume of fresh air combined with the inlet-side compression process is called supercharging. Since the energy for supercharging is taken from the fast flowing, very hot exhaust gases by the turbine, the overall efficiency of the internal combustion engine is increased.

High demands are placed on the EGTs. This is primarily due to the high exhaust gas temperatures of in excess of 1000° C. and the totally different gas volumes, which vary according to rotational speed range, and the high maximum rotational speeds of up to 400,000 revolutions per minute. Conventional EGTs are composed inter alia of a turbine housing and a compressor housing, both of which are fixed to a bearing housing. For that purpose the bearing housing has a flange on the turbine side and a flange on the compressor side, with the turbine housing being connected to the turbine-side flange with the aid of securing means, preferably by means of bolts. Whereas the temperature of the turbine housing can be increased by the hot exhaust gas stream depending on rotational speed also to different high temperatures, the bearing housing largely remains in the normal temperature range, in particular also owing to the air cooling from the compressor side. As a result an extremely time-variable and in part also very high temperature gradient is established in particular along the bolts from the turbine housing to the bearing housing. In order for the bolts to be able to apply the necessary high tensile stress to the turbine housing, they must be sufficiently pretensioned to join the turbine housing to the bearing housing in a force-fitting and form-fitting manner over the entire operating temperature range. Tests conducted by the applicant have shown that the bolts in particular at very high exhaust gas temperatures in the higher rotational speed range the pretension can become negative due to the thermal expansion of the bolts. There exists the risk that the bolt head will lift off from the turbine-side flange of the bearing housing with the result that no reliable connection between turbine housing and bearing housing is ensured. Since the turbine housing generally has end-to-end bore holes, there is in particular the risk of leakages. Furthermore the bolts must be manufactured from an expensive special material in order to withstand the high loads. The recesses for the bolts for securing the turbine housing to the bearing housing are also located at points that are difficult to access, since for constructional reasons the bearing housing has a smaller diameter between compressor wheel and turbine wheel. Consequently the securing means must be tightened manually in order to flange-mount the turbine housing onto the bearing housing.

It is the object of the present invention to reduce the aforementioned disadvantages.

This object is achieved according to the invention by means of a turbocharger having the features recited in claim 1, and by means of a method having the features recited in claim 8.

Accordingly the inventive object is:
To provide a turbocharger for a motor vehicle or in a motor vehicle, the turbocharger comprising a compressor housing, a turbine housing and a bearing housing having at least one compressor-side flange, wherein the turbine housing is connected to the bearing housing in a force-fitting manner with the aid of a securing means arranged on the compressor-side flange.
To provide a method for assembling a turbocharger wherein in a first production step a bearing housing is mounted onto a turbine housing, then, in a further production step, an inventive securing means is used to secure the turbine housing and automatically bolted, and finally, in a further production step, a compressor housing is mounted.

The concept underlying the present invention consists in securing the turbine housing with the aid of a securing means which applies the tensile stress from the compressor-side flange of the bearing housing. An advantage is that owing to the now substantially greater length of the inventive securing means the temperature gradient is lower, i.e. the mean temperature of the securing means is less and consequently the temperature-related change in length of the securing means referred to the length of the bolt is substantially less. Tests conducted by the applicant have shown that with the inventive securing means a considerable pretensioning force is exerted onto the turbine housing by the securing means even at high exhaust gas temperatures. Furthermore it becomes possible to use a lower-cost basic material for the securing means as a result of the lower average temperature.

A further advantage in the use of the inventive securing means lies in the fact that a method for automatic assembly of turbochargers is provided in which the bolt head is freely accessible for the first time. The turbine housing can be manufactured considerably more easily and more cost-effectively.

Advantageous embodiments and developments of the invention will emerge from the dependent claims as well as from the description in conjunction with the drawings.

According to one embodiment variant the compressor-side flange of the bearing housing has a molding for receiving the securing means. This enables the head of the securing means to be countersunk as far as possible in the compressor-side flange of the bearing housing. Advantageously the securing means is embodied as a bolt acting as a tie rod.

According to another embodiment variant the length of the thread of the bolt is not longer than the thickness of the turbine housing, it also being advantageous that in the area of the thread the bolt has a greater diameter than the shaft diameter. As a result a greater material cross-section is available for absorbing the tensile force in the high temperature load range.

According to another embodiment variant it is advantageous if the thread of the bolt is embodied as a self-sealing thread.

Furthermore it is advantageous if the securing means, in particular bolt, has a head with internal engagement, a hexagon socket for example.

The invention is explained in more detail below with reference to the exemplary embodiments illustrated in the figures of the drawings, in which:

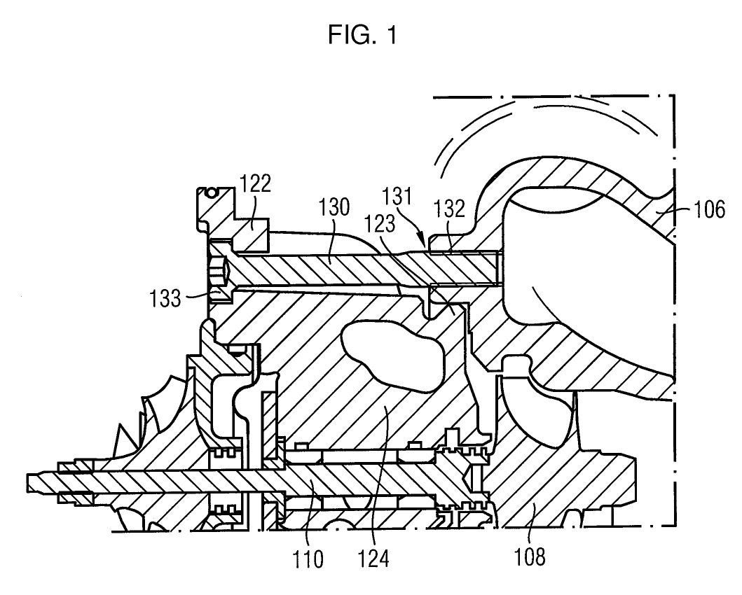

FIG. 1 is a schematic representation of an inventive fixing of a turbine housing;

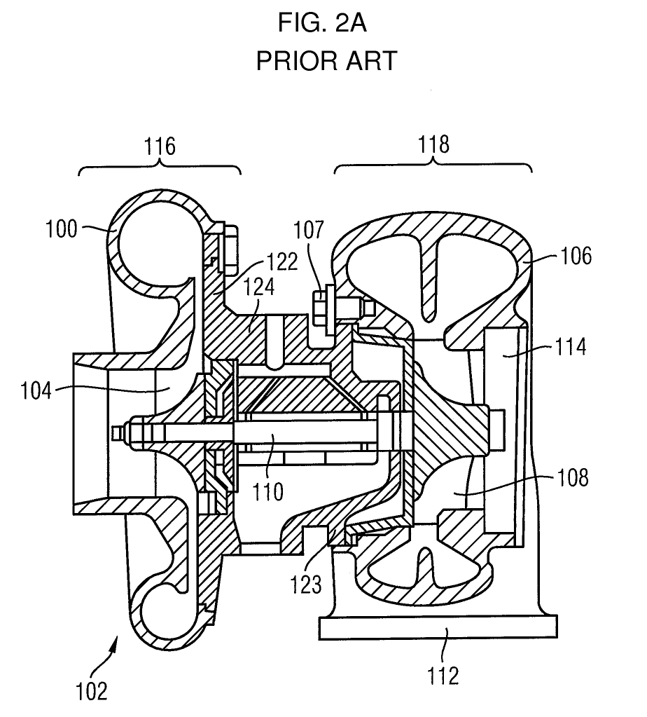

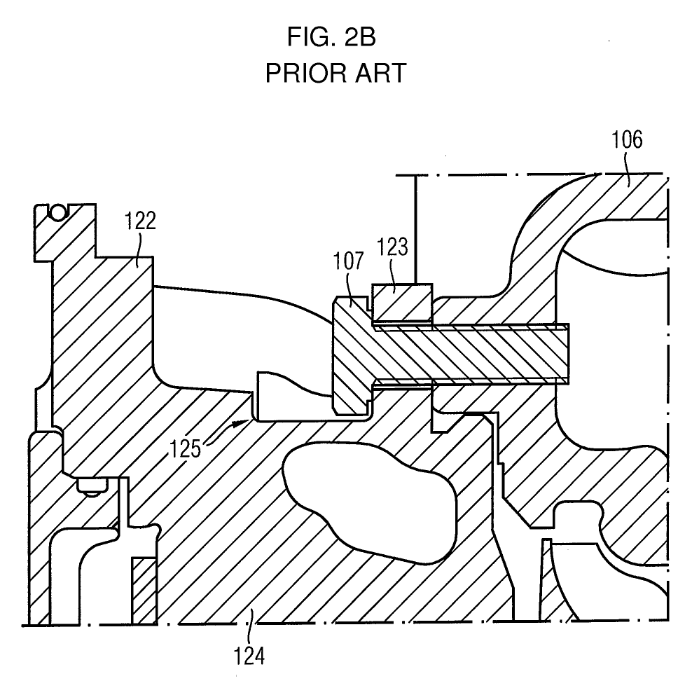

FIG. 2a shows a schematic layout of an exhaust gas turbocharger having a turbine housing fixing according to the prior art;

FIG. 2b is a schematic detailed representation of the fixing of a turbine housing.

Unless otherwise indicated, identical and functionally identical elements, features and dimensions are labeled with the same reference signs throughout the figures.

FIG. 2a shows a layout of an exhaust gas turbocharger 102 according to the prior art, comprising a turbine 118 and a compressor 116. A turbine wheel 108 is rotatably mounted inside a turbine housing 106 of the exhaust gas turbine 118 and connected to one end of a shaft 110. A compressor wheel 104 is likewise rotatably mounted inside the compressor housing 100 of the compressor 116 and connected to the other end of the shaft 110. Hot exhaust gas from a combustion engine (not shown here) is admitted via a turbine inlet 112 into the turbine 118, as a result of which the turbine wheel 118 is set into rotation. The exhaust gas stream exits the turbine 118 through a turbine outlet 114. The turbine 118 drives the compressor 116 via the shaft 110 which couples the turbine wheel 108 to the compressor wheel 104. On the downstream side the turbine housing 106 is secured by means of a bolt 107 to the turbine-side flange 123 of the bearing housing 124. On the upstream side the compressor housing 100 is secured to the compressor-side flange 122 of the bearing housing 124.

FIG. 2b shows a schematic detailed representation of an exhaust gas turbocharger according to the prior art. According thereto, the turbine housing 106 is secured to the turbine-side flange 123 of the bearing housing 124 by means of a short bolt 107. Since for constructional reasons the diameter of the bearing housing 124 between the compressor-side flange 122 and the turbine-side flange 123 is substantially smaller and the bearing housing has a recess 125 for receiving the head of the bolt, the threaded connection of the turbine housing must be introduced and screwed in manually in a time-intensive manner.

FIG. 1 shows a schematic representation of an inventive fixing of a turbine housing 106 to a bearing housing 124. The turbine housing 106, which is mounted in a form-fitting manner to the turbine-side flange 123 of the bearing housing 124, encloses a turbine wheel 108 disposed on a shaft 120. The force fit between turbine housing 106 and bearing housing 124 is created by means of a long bolt 130 which is inserted through a recess of the compressor-side flange 122. The long bolt 130, embodied as a tie rod, is pretensioned in order to secure the turbine housing 106 reliably to the bearing housing 124 even at high exhaust gas temperatures. The bolt 130 has a threaded section 132 which is preferably turned in completely into the turbine housing 106. Tests conducted by the applicant have shown that it is also advantageous if the compressor-side flange 122 has a recess for receiving the bolt head 133 of the bolt 130. A disruptive swirling of the air mixture that is to be compressed on the compressor side is reduced thereby. It is also conceivable to use other types of fixing than screwed connections, such as, for example, stud bolts or plug-and-socket connections using rivets, or locking rings.

An advantage of the inventive fixing is that the bolts have a long length as a result of the threaded connection of the turbine housing to the compressor-side flange and the temperature difference can be distributed over a substantially greater length. The average temperature of the threaded tie rod connection is less than in the case of a short bolt according to the prior art. This means that a lower-cost basic material can be used for the material of the bolts. A further advantage is that the effect of a different thermal coefficient of expansion of the material of the turbine housing and of the material of the bolts, which is the cause of a drastic reduction in, extending as far as total dispersion of, the pretensioning force in the case of short bolt lengths, is greatly diminished owing to the greater expansion lengths. The reliability of the threaded connection is increased. Another advantage is that the bolts no longer have to be manually introduced and tightened between the compressor-side and turbine-side flanges during the manufacture of the turbocharger. In addition to a considerably more efficient and consequently cost-effective production of the turbochargers, reliability is further increased as a result of the automated threaded connection, since the pretensioning force can be preset on automated production equipment. Tests conducted by the applicant have shown that totally automated high-volume production of turbochargers is made possible by means of the inventive embodiment. In particular the balanced bearing housing which has rotor and mounting can be installed in the turbine housing, which is preferably clamped vertically at the assembly station, with the compressor side upward. Following this, both are bolted together with the aid of the securing means, likewise supplied from above, preferably bolts embodied as tie rods. The compressor housing is subsequently mounted and secured.

1-8. (canceled)

9. A turbocharger for or in a motor vehicle, comprising:
a compressor housing;
a turbine housing;
a bearing housing formed with at least one compressor-side flange on a side thereof facing said compressor housing;
a securing device mounted to said compressor-side flange of said bearing housing and connecting said turbine housing to said bearing housing in a force-fitting manner.

10. The turbocharger according to claim 9, wherein said compressor-side flange of said bearing housing has a molding for receiving said securing means.

11. The turbocharger according to claim 9, wherein said securing means is a bolt acting as a tie rod.

12. The turbocharger according to claim 11, wherein said turbine housing has a given thickness and said bolt is formed with a thread, and wherein a length of said thread is no longer than the thickness of said turbine housing.

13. The turbocharger according to claim 11, wherein said bolt has a shaft and a diameter of said shaft is smaller than a diameter of said thread.

14. The turbocharger according to claim 13, wherein said thread of said bolt is configured as a self-sealing thread.

15. The turbocharger according to claim 9, wherein said securing means has a head with internal engagement.

16. A method of assembling a turbocharger, the method which comprises:
in a preliminary step, providing a compressor housing, a turbine housing, a bearing housing formed with at least one compressor-side flange on a side thereof facing said compressor housing, and a securing device;
in a first production step, placing the bearing housing onto the turbine housing;
in a further production step, inserting the securing device and automatically bolting the securing device for securing the turbine housing; and
in a further production step, mounting the compressor housing to the bearing housing.
